(19) United States
(12) Patent Application Publication
(10) Pub. No.: US 2017/0052581 A1
(43) Pub. Date: Feb. 23, 2017

(54) Device and Method for Combined Data and Power Transmission

(71) Applicant: Curbell Medical Products, Inc., Orchard Park, NY (US)

(72) Inventor: Donald J. Enzinna, Lockport, NY (US)

(21) Appl. No.: 15/242,085

(22) Filed: Aug. 19, 2016

Related U.S. Application Data
(60) Provisional application No. 62/207,342, filed on Aug. 19, 2015.

(51) Int. Cl. G06F 1/26; G06F 1/28

(52) U.S. Cl. CPC G06F 1/266; G06F 1/28

(57) ABSTRACT

A device for receiving data and power from a host line. The device includes a microprocessor configured to receive power from the host line by way of a diode and a voltage regulator. Wherein a supply voltage of the microprocessor is maintained by a capacitor configured to charge using a logic high of the host line. The microprocessor includes a receive pin for receiving a signal from the host line. The microprocessor communicates using a communication protocol having bytes with limited successive logic low bits. A method for communicating by way of a host line is provided, the method using microprocessor powered by the host line.

### CROSS-REFERENCE TO RELATED APPLICATIONS

This application claims priority to U.S. Provisional Application No. 62/207,342, filed on Aug. 19, 2015, now pending, the disclosure of which is incorporated herein by reference.

### FIELD OF THE DISCLOSURE

The disclosure relates to data transmission, and techniques for transmitting data and power over a single line.

### BACKGROUND OF THE DISCLOSURE

In many applications it is convenient to minimize the number of connections or wires between two communicating devices. Generally remote devices that communicate with a host require a ground connection, power, and one or more data connections. Often there is a wire for data from the host to the remote and a separate wire provided for data from the remote back to the host. It is common to combine the data wires so that data can be bidirectional in a configuration known as half duplex. In this configuration, it is up to the host and the remote to share the single wire resource and not attempt to transmit data while receiving.

It is known that the wire carrying data can also be used to supply power to the remote device. For example, some hospital room pillow speakers rely on this principle. In a typical configuration, a wire carries power from the television to the pillow speaker, and proprietary television serial codes are transmitted by the pillow speaker to the TV over the same wire. There are also commercially available systems that provide similar functionality, most notably the “One Wire” system provided by Dallas Semiconductor. This protocol is well documented but it requires “bit banging” or forcing a microcontroller to drive the data line high and low at the appropriate times to achieve proper timing for the protocol.

There is a need for the ability to provide data and power over the same line to supply power for the device without the need for a microcontroller in the device to provide careful signal timing.

### BRIEF SUMMARY OF THE DISCLOSURE

A device for receiving data and power from a host line configured for communication at a host voltage is presented. The device includes a microprocessor operating at a device voltage and having a supply input and a receive pin. The receive pin is configured to connect to the host line. The device may include an input buffer configured to connect the host line to the receive pin of the microprocessor. The input buffer may conform logic levels of the host line to logic levels of the microprocessor. A transmit pin of the microprocessor may be configured to connect to the host line. For example, an output driver may be configured to connect the transmit pin to the host line. The output driver may be operable to switch the host line to ground according to a data transmission of the transmit pin.

The device includes a voltage regulator having an input and an output. The output is configured to connect to the supply input of the microprocessor for supplying the device voltage. The voltage regulator has a dropout voltage. A diode is configured to unidirectionally connect the host line to the input of the voltage regulator. As such, an anode of the diode is configured to connect to the host line and a cathode of the diode is connected to the input of the voltage regulator. The diode has a forward drop voltage. A capacitor is configured to couple the cathode of the diode to ground. The capacitor has a capacitance selected to maintain a voltage at the cathode of the diode which is greater than a sum of the dropout voltage of the voltage regulator and the device voltage. For example, the forward drop voltage of the diode may be less than the host voltage minus the sum of the dropout voltage of the voltage regulator and the device voltage. In some embodiments, the capacitor is configured to discharge during a logic low of the host line to maintain at least a minimum input voltage of the voltage regulator. In some embodiments, the capacitor is configured to charge to a sufficient level during a logic high of the host line such that a logic high is received by the microprocessor.

The microprocessor is programmed to communicate using a communication protocol which limits a number of successive logic low bits. In some embodiments, the communication protocol is configured to include no more than two successive logic low bits in any byte.

In another aspect, the present disclosure provides a method of communication using a microprocessor with on-chip serial communication hardware and non-return to zero (“NRZ”) signaling. The method includes unidirectionally connecting a supply input of the microprocessor to a host line using a diode, such that the microprocessor is powered by the host line. A cathode of the diode is coupled to ground using a capacitor configured to charge during a logic high of the host line and to discharge during a logic low of the host line. In this way, a sufficient voltage is maintained at the supply pin of the microprocessor to provide uninterrupted power to the microprocessor.

An NRZ signal is received from the host line using a receive pin of the microprocessor. The NRZ signal is formatted with a communication protocol configured to limit a number of successive logic low bits. For example, in some embodiments, the communication protocol does not include any bytes having three or more successive logic low bits.

The method may further include transmitting an NRZ transmit signal on the host line using a transmit pin of the microprocessor. For example, the host line may be switched to ground in order to transmit a logic low bit.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram depicting the typical timing for serial transmission of an eight-bit byte;

FIG. 2 is a diagram of a device according to an embodiment of the present disclosure;

FIG. 3 is a shows the reception of an ASCII ‘@’ character (40 hexadecimal or ‘0x40’);

FIG. 4 is a diagram showing the transmission of a byte having the value of 0x66;

FIG. 5A is a diagram showing the timing of a byte having the value of 0x33;

FIG. 5B is a diagram showing the timing of a byte having the value of 0x34; and

FIG. 6 is a chart of a method according to an embodiment of the present disclosure.

### DETAILED DESCRIPTION OF THE DISCLOSURE

The present disclosure provides a way to use on-chip peripherals to generate data waveforms without direct intervention of the microcontroller. Specifically, there is a peripheral built into almost all microcontrollers for generating asynchronous serial communication. This protocol has not been effectively used in the past due to the potential for lengthy period of a low logic level, which would un-power the microcontroller and force a reset. The present disclosure provides devices and methods for limiting the time that a data line can be driven low, thereby circumventing the problems associated with loss of power and accidental resets.

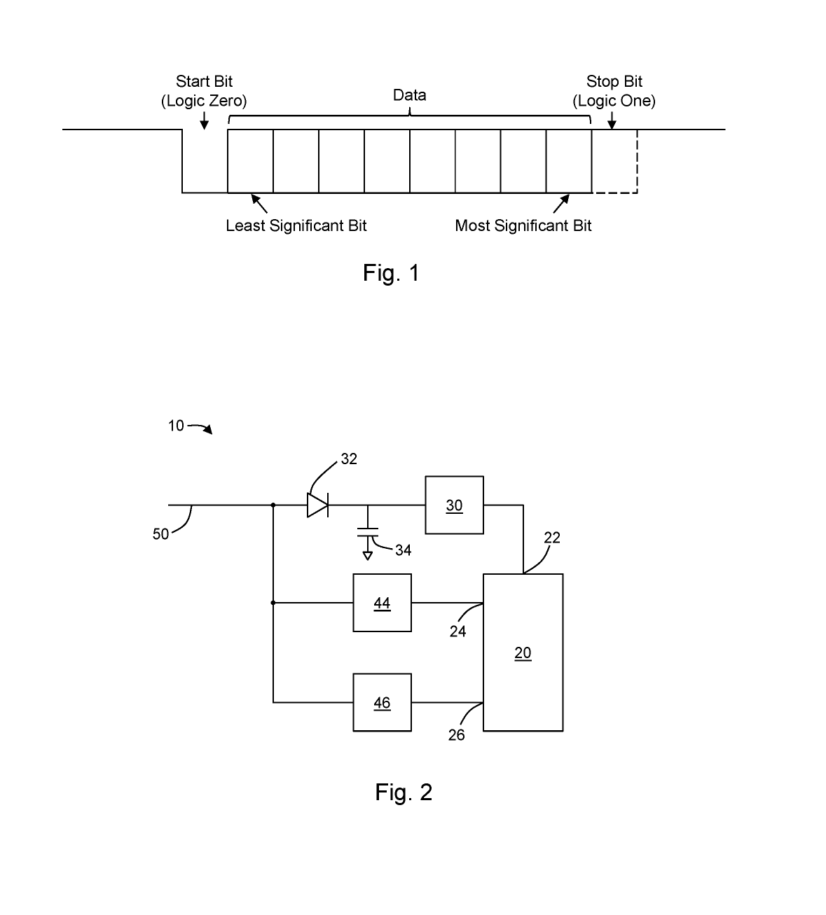

FIG. 1 shows the typical timing for serial transmission of an eight-bit byte. Transmission begins with a start bit, followed by data bits and lastly, a stop bit. There are usually a number of agreed upon parameters that are worked out between the transmitter and receiver. Such parameters are often pre-determined or negotiated. For example, parameters such as the width of each bit, the number of data bits, the number of stop bits, and the use of an optional parity bit, must match at both ends (host and device) for effective communication. The timing of the communication is typically expressed as baud rate (bits per second) and is often limited to a set of standard values in multiples of 1200, for example, 1200, 2400, 4800, 9600, etc. baud. A rate of 9600 bits per second results in a bit width of 1/9600 seconds or just over 104 microseconds. The transmission time of the full byte of 10 bits shown in FIG. 1 represents a time period of 1.042 milliseconds.

As described above, the number of data bits can vary. Although 8-bit bytes are most common, the number of data bits often ranges from 6 to 9. The stop bit can also vary between 1 and 2. The use of a parity bit is a simple technique to check for corrupted data. A parity bit can be inserted just before the stop bit, and it can be defined as even or odd and its logic state is such that all the one bits in the data are either even or odd in number. Thus, if one bit is misinterpreted because of noise or some external factor, the parity bit will not match the number of received one bits and measures can be taken to retransmit or flag an error. Typically, the communication parameters are expressed as in a format similar to 9600, 8, N, 1 where 9600 is the baud rate, 8 is the number of data bits, N means no parity, and 1 means one stop bit. This is the configuration shown in FIG. 1.

FIG. 2 shows a block diagram of a device 10 according to the present disclosure that employs a single wire host line 50 to carry both data and power. A host system, not shown but connected to the host line 50, supplies power to the host line 50 through a pull-up resistor or other current limiting technique for supplying power. Supplying power using current limiting allows the host line 50 to be periodically pulled low during the transmission of data. It should be noted that when referring to a single wire, it is assumed that the device 10 and the host system are similarly grounded or otherwise commonly referenced as is known in the art. Solely for convenience, the low reference will be referred to as “ground” throughout this disclosure. In the idle state (i.e., when no data is being transmitted on the host line 50), the host line 50 will be maintained at some non-zero voltage.

The device 10 comprises a voltage regulator 30 for providing a device voltage at an output. The voltage regulator 30 has an input which is connected to the host line 50 by way of a diode 32. The diode 32 has an anode connected to the host line 50 and a cathode connected to the input of the voltage regulator 30. In this way, the voltage regulator 30 is unidirectionally connected to the host line 50 such that current can only flow from the host line 50 to the voltage regulator 30 (under normal operating conditions—i.e., voltages do not exceed a breakdown voltage of the diode 32). The voltage regulator 30 has a dropout voltage, which is the smallest difference between the voltage at its input and its output while remaining in regulation. The diode 32 has a forward drop, which is the voltage difference between the anode and the cathode when the diode 32 is forward biased.

The device 10 further comprises a capacitor 34 coupling the input of the voltage regulator 30 to ground. Current will flow through the diode 32 into the capacitor 34 until it is charged up to the idle state voltage (host voltage) of the host line 50, less any voltage drop of the diode 32.

The device 10 comprises a microprocessor 20 which operates at a device voltage. The microprocessor 20 includes a supply input 22 and a receive pin 24. The voltage regulator 30 is employed to reduce the voltage at the capacitor 34 down to the device voltage required by the microprocessor 20. As such, the supply pin 22 is connected to the output of the voltage regulator 30. In some embodiments, the microprocessor 20 includes a transmit pin 26. The receive pin 24 is connected to the host line 50. The receive pin 24 may be connected to the host line 50 by way of an input buffer 44. The input buffer 44 is configured to conform the logic levels at the host line 50 to the logic levels required at the microprocessor 20 receive pin 24. It should be recognized that the use of the term “pin” should not be viewed as limiting the present disclosure to a particular type of microprocessor and is intended to refer to any type of microprocessor connection.

The capacitor 34 is configured to store energy and maintain a voltage at the input of the voltage regulator 30 which is greater than a sum of the drop-out voltage of the voltage regulator 30 and the device voltage of the microprocessor 20. As such, the capacitor 34 is sized (i.e., has a capacitance) such that its discharge rate can maintain the voltage at the voltage regulator 30 during any logic low period of the host line 50. Further, a communication protocol used between the host system and the device 10 on the host line is configured to limit the number of successive logic lows (as further described below).

In some embodiments, the transmit pin 26 of the microprocessor 20 is connected to the host line 50. The transmit pin 26 may be connected to the host line 50 by way of an output driver 46. The output driver 46 may operate essentially as a switch to ground that enables the microprocessor 20 to periodically drive the host line 50 to a low voltage thereby signaling a logic zero. In this manner, the microprocessor 20 may transmit data on the host line 50 while not sourcing current to the host line 50. It should be noted that the output driver 46 is described as operating essentially as a switch, but one having skill in the art would understand that such functionality of the output driver 46 could be implemented through various designs.

In an illustrative example, 5-volt logic is used at the host line 50 and the microprocessor 20 operates at a device voltage of 3.3 V. Thus, anything near 5 V on the host line 50 represents a logic one or the idle state, and 3.3 V represents the same to the microprocessor 20. If the diode 32 is a Schottky-type diode, the forward drop is approximately 0.4 V. The voltage regulator 30 is a low dropout type (LDO) with 0.2 V dropout voltage. Thus, capacitor 34 can never charge to more than about 4.6 V (5 V host voltage minus diode 32 forward drop) and a minimum 3.5 V (the “minimum input voltage”) is needed to keep the voltage regulator 30 output from deviating from 3.3 V. This provides a headroom of 1.1 V (maximum charge of the capacitor 34 minus the minimum required at the voltage regulator 30) meaning that the capacitor voltage can droop up to 1.1 V during the transmission of logic zero data during which time the capacitor 34 discharges.

The microprocessor 20 consumes current and, in the present example, a typical value of 200 μA is used. This current represents a continuous drain on the charge held in the capacitor 34. The voltage—current relationship across a capacitor is given as:

$$I = C \frac{d v}{d t} \qquad ( 1 )$$

In the worst case scenario, a byte having a value of 0 is to be transmitted. Assuming an 8-bit byte plus 1 parity bit, transmitted at 9600 baud (bits per second), this means the host line 50 must be driven low for 9/9600 of a second or about 938 μs. Substituting dt=938×10⁻⁶, dv=1.1 and I=200×10⁻⁶ and solving for C, a capacitor 34 is required having a capacitance of at least 0.17 μF.

Examining what happens when the output driver 46 is released during the stop bit time. As mentioned before, the host line 50 is pulled high at the host system by, for example, a resistor. Assuming typical value for such a resistor of 1000 Ohms, the current through the output driver 46 is 5 mA. By using a current limit, constraints are placed on the charging of the capacitor 34. For example, assuming that the capacitor 34 is discharged to 3.5 V when the host line 50 is released, the voltage on that line should be 0.4 V higher (i.e., 3.9 V) factoring the forward drop of diode 32. Assuming that for a reliable logic 1 signal, the host line 50 should be at 90% of the normal logic 1 voltage of 5.0 V, then the host line 50 should be at least 4.5 V for a logic 1. Therefore, starting at 3.9 V, the amount of time required to get up to 4.5 V is can be determined. The voltage across a capacitor in an RC circuit is given as:

$$V ( t ) = {V}_{applied} ( 1 - {e}^{- \frac{t}{RC}} ) \qquad ( 2 )$$

In the example, the applied voltage is 5 V minus the 3.9 V initial condition or 1.1 V. To find the time when the voltage across the capacitor 34 has increased 0.6 volts, equation (2) is solved for t, resulting in t=118 μs. This poses a dilemma since the stop bit is only 104 μs wide and the bit state is usually sampled by the receiver at mid-point or 52 μs. If the stop bit is interpreted as a logic low, there will be a framing error and the communication link may break down. If the size of the capacitor 34 is decreased to get a faster rise time, there will be excessive droop and the microprocessor 20 may reset. Lowering the value of the pull-up resistor to source more current onto the host line 50 can help but it comes at the expense of power dissipation. The capacitor 34 is configured (e.g., has a capacitance selected) to charge to a sufficient level during a logic high of the host line such that a logic high is reliably received by the microprocessor 20.

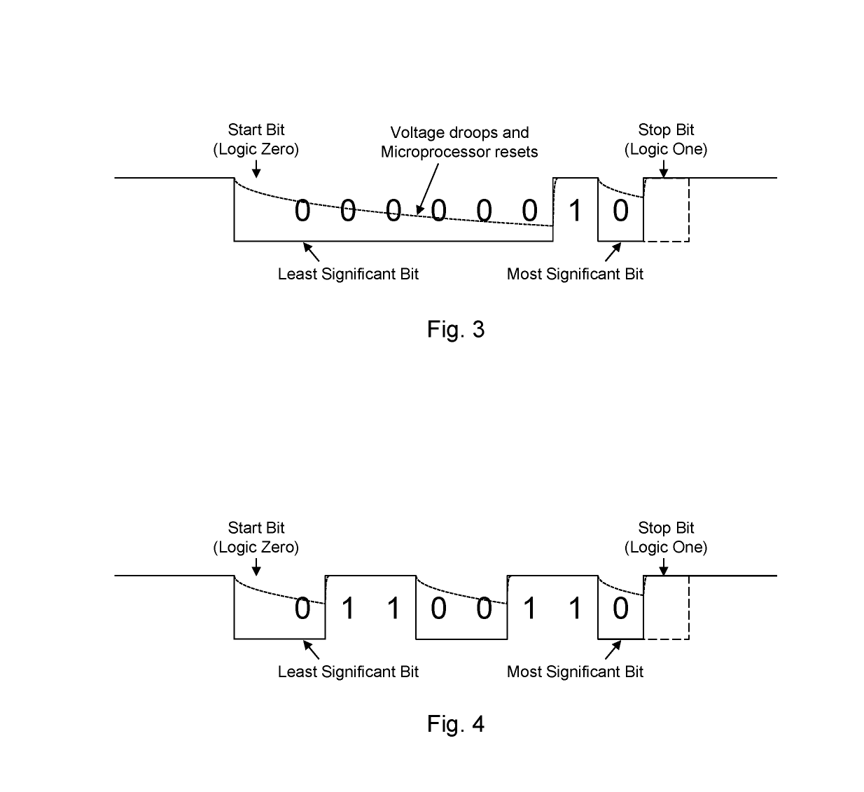

FIG. 3 shows the reception of an ASCII ‘@’ character which is 40 hexadecimal, usually written as 0x40. The 6 least significant bits are all zeroes and are transmitted in succession. During this time, the voltage on the capacitor 34, shown in the trace depicted by the dashed line, decays exponentially from the initial 5 V as current is consumed by the microprocessor 20. At some point during the transmission of the successive zeroes, the voltage will fall to a level that is unable to sustain operation of the microprocessor 20 resulting in a reset.

As such, the present disclosure provides a protocol for ensuring that timing constraints can be met. Other existing protocols, such as that used for Dallas Semiconductor's “One Wire,” use special timing rather than the non-return to zero (NRZ) signaling used for asynchronous serial. As stared earlier, it is desirable to use standard asynchronous serial NRZ because there is hardware in most microprocessors that makes this easy and eliminates the need for direct control by the microprocessor. As such, the present disclosure provides a protocol that eliminates the bytes that lead to bit patterns that cause lengthy logic zero states.

One option is to only use bytes that have a single zero bit. This includes (in Hexadecimal) 0xFF, 0x7F, 0xBF, 0xDF, 0xEF, 0xF7, 0xFB, 0xFD and 0xFE. 0xFE can be eliminated because it would make the least significant bit zero and put two zero bits (the start bit and the least significant bit) adjacent to each other. For an 8-bit word, this leaves eight unique messages. The number of unique messages can be expanded to 64 by using a combination of two bytes to send messages. Because the time between the two bytes can be controlled, the design can provide that the timing constraints are not violated. Because the longest zero bit time would be 104 μs, a 0.022 μF capacitor will hold up long enough to avoid excessive voltage droop. The smaller capacitor will only take about 14 μs to charge, which is within the timing of the stop bit.

Another option is to allow for up to two adjacent low bit periods. Such a configuration doubles the maximum zero bit time to 208 μs so the 0.022 μF capacitor can be replaced with 0.047 μF capacitor to provide more charge. The expected voltage droop on the capacitor can be calculated to be about 1.5 percent or less than 70 mV. The charging time also doubles to 28 μs but still far short of the anticipated bit sample time at 52 is. By allowing up to two adjacent bit times, the number of permissible messages is expanded to over 100 unique single-byte messages. This allows transmission using only one byte and speeds up communication

FIG. 4 shows the transmission of the byte 0x66 with two periods (each period being the duration of a bit) of double-zero low output, each about 208 μs long, and one period of single-zero low output. The trace shown by the dashed line represents the voltage droop in the capacitor. During the time when the signal is at a logic zero or low, the dashed line represents the capacitor discharging, and when the signal is at a logic one or high, the dashed line shows the host line being re-charged.

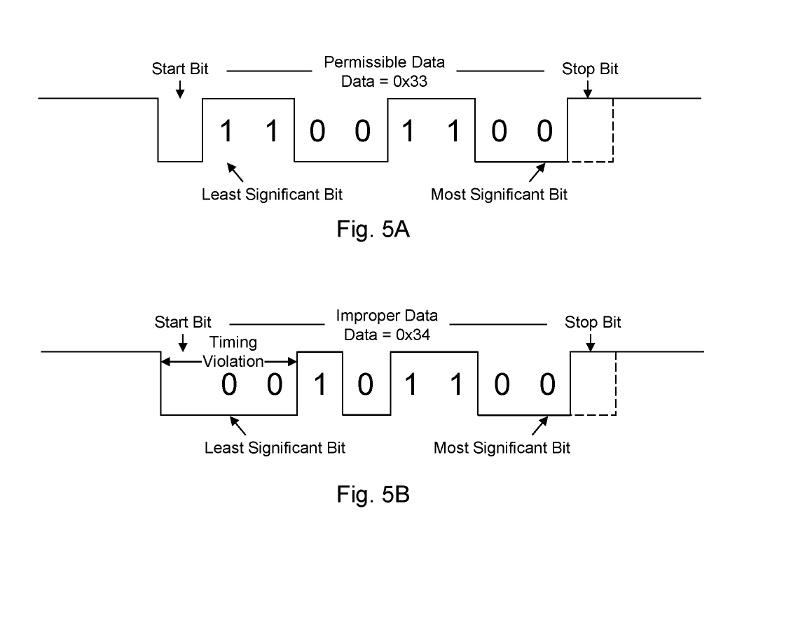

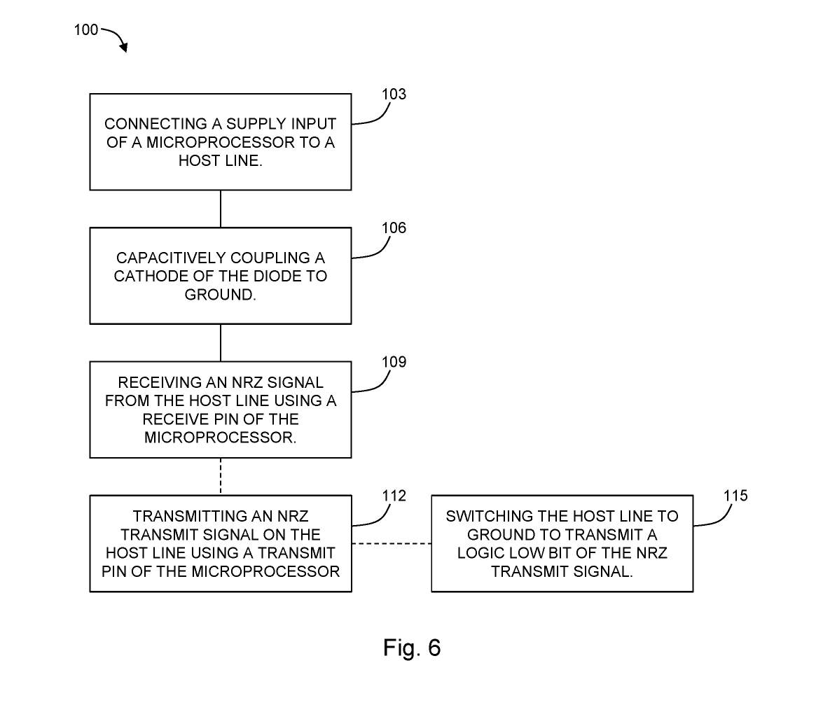

If the communication protocol is designed to allow one or two sequential logic low periods in the data stream, but never three or more, the character set is limited as stated above. Because the start bit is zero (since the host line is maintained high when idle), the value of the lower nibble can be a ‘2’ or ‘3’ but not a ‘4’ because a ‘4’ would put three sequential zero bits in the data stream. Likewise a ‘0’, ‘8’ or ‘C’ would not be allowed. A ‘1’ would not be allowed since the three upper bits in that nibble would be zero. Since the upper nibble is adjacent to the lower nibble, the choice of anything less than ‘8’ in the lower nibble would preclude some choices of upper nibbles. For instance sending a ‘3’ in the lower nibble would put two sequential zeroes in the upper two bits of the lower nibble and eliminate a zero bit in the ones bit of the upper nibble. So a 0x33 would be permissible (FIG. 5A) but a 0x34 would not (FIG. 5B).

Table 1 shows a list of permissible bytes under these exemplary constraints. There are 100 permissible bytes using this exemplary protocol.

TABLE 1
Allowable byte values in hexadecimal

| FF | EF | DF | CF | BF | AF | 9F | 7F | 5F | 4F | 3F | 2F |
|---|---|---|---|---|---|---|---|---|---|---|---|
| FE | EE | DE | CE | BE | AE | 9E | 7E | 5E | 4E | 3E | 2E |
| FD | ED | DD | CD | BD | AD | 9D | 7D | 5D | 4D | 3D | 2D |
| FB | EB | DB | CB | BB | AB | 9B | 7B | 5B | 4B | 3C | 2C |
| FA | EA | DA | CA | BA | AA | 9A | 7A | 5A | 4A | 3A | 2A |
| F9 | E9 | D9 | C9 | B9 | A9 | 99 | 79 | 59 | 49 | 39 | 29 |
| F7 | * | D7 | * | B7 | * | 97 | 77 | 57 | * | 37 | * |
| F6 | * | D6 | * | B6 | * | 96 | 76 | 56 | * | 36 | * |
| F5 | * | D5 | * | B5 | * | 95 | 75 | 55 | * | 35 | * |
| F3 | * | D3 | * | B3 | * | 93 | 73 | 53 | * | 33 | * |

Note:
* = not allowed

How the 100 bytes will be used is determined according to the particular application at hand. For example, where the host/device system is a host and a keyboard, the host may periodically poll the keyboard to determine if any keys are pressed. Because the keyboard only replies to a poll from the host, there exists a de-facto master-slave relationship between the two. Firmware in the keyboard will wait and answer requests from the host as they are issued.

The disclosed encoding scheme has inherent error detection. If traditional error detection were used, the number of allowable byte values would be reduced. For example, if a parity bit were implemented for error detection, the added bit would eliminate some of the 100 allowable bytes because the parity bit will be zero at times, precluding the use of two zero upper bits in the upper nibble. A checksum could be used, but it may be cumbersome or unworkable to ensure the bytes of the checksum comply with the limited number of zero bits. However, due to the inherent characteristics of the disclosed method, these common error detecting methods will not be needed in the exemplary application. Firmware in the keyboard can scan the keypad on receipt of a poll command from the host and deliver a list of byte codes for up to 36 keys, followed by an end of message byte. If no keys are pressed, only the end of message byte is sent. It is up to the host to periodically poll the keypad and de-bounce the key data. In a typical implementation, the host will send a poll command every 40 milliseconds and look for a key or keys that are present in two or more sequential polls. Thus, if spurious data is received, the de-bounce algorithm will reject it. Bytes that do not belong to the set of 100 permissible values can be ignored. All valid key messages are received at least twice.

To implement the above exemplary embodiment, a poll byte, an end of message byte, and 36 unique bytes, one for each key in a 6 by 6 matrix, are needed. For the additional control of up to four outputs, one byte is needed to turn on each output, and another to turn each off, requiring another eight bytes. The host can reset the keyboard at any time by driving the host line low and holding it low long enough to drain the capacitor in the keypad. As such, there is no need for a reset byte, but a reset byte may be reserved for future expansion. This adds up to 47 bytes needed for unique messages, leaving 47 for expansion. Of those remaining 47, ten may be used for device ID bytes where a keypad will transmit a byte identifying a model type to the host when coming out of reset.

Byte values can be assigned to functions in an arbitrary manner, so, for example, all bytes from 0xFF down to 0xB3 can be assigned to the 36 keys with 6 spares. Bytes 0xAF down to 0xA9 may be assigned to control functions, include Poll, End of Message, and Reset. Further, bytes 0x9F to 0x93 may be assigned as model type ID. This leaves bytes 0x3f down to 0x33 as output control bytes and bytes 0x7F to 0x49 and 0x2F to 0x29. Depending on what is controlled by the outputs, driving one or more to an active state may be beyond the scope of a combined power and data host line device. For instance, if the outputs control LEDs, there may not be enough current to both light the LEDs and power the keyboard. In such cases, an independent power source may be used to provide and or supplement the power.

For the purposes of the present example, the Poll byte is assigned to 0xA9 and the End of Message to 0xAA. As such, below is a summary of an exemplary message exchange between the host and a keypad:
1. A keypad is plugged into the host system. The keypad resets, initializes itself, and sends an ID byte 0x93. The host is now aware that a keypad of model type 0x93 is active.
2. The host sends a poll command, 0xA9
3. The keypad receives 0xA9 and interprets it as a poll command. The keypad scans the keys and finding no keys down, transmits an end of message, 0xAA
4. The host recognizes an empty data packet and interprets it as no keys down.
5. Steps 2-4 are repeated at a 25 Hz rate until a key down is encountered. At any time, if the keypad fails to answer a poll in a predetermined amount of time, the host takes action on a cord-out (e.g., holds the host line at a low value for a period long enough to reset the keypad and attempt to re-establish communication).
6. At some point, a user presses a key on the keypad. The next time the host polls the keypad, the keypad detects one or more keys down. The message transmitted by the keypad includes a byte between 0xFF and 0xB3, one for each key detected in the pressed state followed by an end of message 0xAA
7. The host stores each byte until the following poll.
8. On the subsequent poll, the same bytes are returned indicating to the host that the keys are still pressed. With the de-bounce period exceeded, the host can take action on those keys.

The present disclosure may be embodied as a method 100 of communication using a microprocessor. The microprocessor can include on-chip serial communication hardware and non-return to zero (“NRZ”) signaling. The method 100 comprises unidirectionally connecting 103 a supply input of the microprocessor to a host line. The host line can be configured as described above, for communication to a host system. The supply input is connected 103 to the host line using a diode such that the microprocessor is powered by the host line. For example, the anode of the diode may be connected to the host line and the cathode may be connected to the supply pin of the microprocessor. The cathode may be connected to the supply pin by way of a voltage regulator.

A cathode of the diode is capacitively coupled 106 to ground. For example, a capacitor may be connected to the cathode of the diode and to ground (i.e., the low reference as described above). In this way, the capacitor is configured to charge during a logic high of the host line and configured to discharge during a logic low of the host line. As such, a voltage is maintained at the supply pin of the microprocessor, and the voltage is sufficient to provide uninterrupted power to the microprocessor.

The method 100 comprises receiving 109 an NRZ signal from the host line using a receive pin of the microprocessor. In some embodiments, the receive pin is connected to the host line by way of an input buffer. The input buffer may be configured to conform logic levels of the host line to logic levels of the microprocessor. The NRZ signal is formatted with a communication protocol configured to limit a number of successive logic low bits as described above. For example, the communication protocol may be configured so as not to include any bytes having three or more successive logic low bits.

The method 100 may further comprise transmitting 112 an NRZ transmit signal on the host line using a transmit pin of the microprocessor. In some embodiments, the transmit pin of the microprocessor is connected to the host line. For example, the transmit pin may be connected to the host line by way of an output driver. In some embodiments, the host line is switched 115 to ground when a logic low bit of the NRZ transmit signal is transmitted. For example, in embodiments wherein an output driver is provided, the output driver may connect the host line to ground in order to pull the host line to ground—“transmitting” a logic low.

In another aspect, the present disclosure can be embodied as a method for communication, for example, communication between devices. The method comprises receiving and/or transmitting a signal formatted with a communication protocol configured to limit a number of successive logic low bits. As such, the disclosure presents a new communication protocol. In an exemplary embodiment, the communication protocol does not include any bytes having three or more successive logic low bits—in other words, all bytes of the protocol include no more than two successive low bits. Through the use of the presently-disclosed protocol, a device may be, but is not required to be, powered from the same line by which it communicates (as further described above). The disclosed protocol may be suitable for communicating with devices on the same printed circuit board (for example, subcomponents of a larger device), between devices in separate housings, or at other scales (smaller or larger) where such a protocol would be advantageous, as would be apparent to one having skill in the art in light of the present disclosure.

The present disclosure may be embodied as a device configured to transmit a signal formatted using the above-described communication protocol. The present disclosure may be embodied as a device additionally or alternatively configured to receive a signal formatted using the above-described communication protocol.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

What is claimed is:

1. A device for receiving data and power from a host line configured for communication at a host voltage, comprising:
a microprocessor operating at a device voltage and having a supply input and a receive pin, the receive pin is configured to connect to the host line;
a voltage regulator having an input and an output, the output being connected to the supply input of the microprocessor for supplying the device voltage, and the voltage regulator having a dropout voltage;
a diode having a cathode connected to the input of the voltage regulator, the diode having an anode configured to connect to the host line such that the input of the voltage regulator unidirectionally connected to the host line, and wherein the diode has a forward drop voltage;
a capacitor configured to couple the cathode of the diode to ground, wherein the capacitor is configured to maintain a voltage at the cathode of the diode which is greater than a sum of the dropout voltage of the voltage regulator and the device voltage; and
wherein the microprocessor is programmed to communicate using a communication protocol which limit a number of successive logic low bits.

2. The device of claim 1, wherein the communication protocol is configured to include no more than two successive logic low bits.

3. The device of claim 1, further comprising an input buffer configured to connect the host line to the receive pin of the microprocessor for conforming logic levels of the host line to logic levels of the microprocessor.

4. The device of claim 1, wherein the microprocessor further comprises a transmit pin configured to connect to the host line.

5. The device of claim 4, further comprising an output driver configured to connect the host line to the transmit pin for switching the host line to ground according to a data transmission of the transmit pin.

6. The device of claim 1, wherein the forward drop of the diode is less than the host voltage minus the sum of the dropout voltage of the voltage regulator and the device voltage.

7. The device of claim 1, wherein the capacitor is configured to discharge during a logic low of the host line to maintain at least a minimum input voltage of the voltage regulator.

8. The device of claim 1, wherein the capacitor is configured to charge to a sufficient level during a logic high of the host line such that a logic high is received by the microprocessor.

9. A method of communication using a microprocessor with on-chip serial communication hardware and non-return to zero (“NRZ”) signaling, the method comprising:
unidirectionally connecting a supply input of the microprocessor to a host line using a diode, such that the microprocessor is powered by the host line;
coupling a cathode of the diode to a capacitor configured to charge during a logic high of the host line and to discharge during a logic low of the host line, thereby maintaining a voltage sufficient to provide uninterrupted power to the microprocessor;
receiving an NRZ signal from the host line using a receive pin of the microprocessor, wherein the NRZ signal is formatted with a communication protocol configured to limit a number of successive logic low bits.

10. The method of claim 9, wherein the communication protocol does not include bytes having three or more successive logic low bits.

11. The method of claim 9, further comprising transmitting an NRZ transmit signal on the host line using a transmit pin of the microprocessor.

12. The method of claim 11, wherein transmitting the NRZ transmit signal comprises switching the host line to ground when a logic low bit is transmitted.
